(19) United States
(12) Patent Application Publication
(10) Pub. No.: US 2009/0109882 A1
(43) Pub. Date: Apr. 30, 2009

(54) PUSH-TO-COMMUNICATE SESSION ASSOCIATING

(75) Inventors: Rod N. Averbuch, Buffalo Grove, IL (US); Anatoly Agulnik, Deerfield, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/931,574

(22) Filed: Oct. 31, 2007

(51) Int. Cl. H04L 5/16

(52) U.S. Cl. 370/296

(57) ABSTRACT

A method (400) and a PTC associating server (116) for handling a push-to-communicate (PTC) communication session. A PTC session initiation request identifying a first PTC address as a destination address can be received (402). The PTC session initiation request can be automatically associated with at least a second PTC address (404). The method further can include automatically generating a session modification request requesting that at least one communication device associated with the second PTC address be added as a participant in the PTC communication session (406).

### BACKGROUND OF THE INVENTION

1. Field of the Invention

The present invention generally relates to mobile communications and, more particularly, to push-to-communicate sessions.

2. Background of the Invention

Push-to-communicate (PTC) services, such as push-to-talk (PTT), PTT over cellular (PoC) and push-to-experience (PTx), are popular both among businesses and individual consumers. Using PTC, a communication link is established between a session initiator (e.g. a caller) and a session target (e.g. the individual or call group being called) virtually instantaneously. Thus, PTC is often considered to be more convenient than other modes of mobile communication.

PTC services are typically supported using half duplex communications. That is, audio and data are communicated only in one direction at a given time. Thus, while one person communicates data, others listen/receive such data. Not until after the person who was communicating has released the communication channel can another person begin transmitting data over the channel.

In PTC, session targets are identified using individual addresses or group identifiers. For example, to initiate a PTT session with a particular individual, the individual's address must be selected to initiate the PTT call. Sometimes a caller may not care which particular individual is contacted in a PTT session, but instead may wish to contact any individual who happens to be performing a certain function or duty at the present moment. For instance, a building manager may wish to speak with the security guard presently on duty for a building, but may not know who is presently scheduled on the duty roster. Without knowledge of which security guard is on duty, the building manager will not know the target address necessary to initiate a PTT session.

### SUMMARY OF THE INVENTION

The present invention relates to a method of handling a push-to-communicate (PTC) communication session. The method can include receiving a PTC session initiation request identifying a first PTC address as a destination address and automatically associating the PTC session initiation request with at least a second PTC address. The method further can include automatically generating a session modification request requesting that at least one communication device associated with the second PTC address be added as a participant in the PTC communication session.

The present invention also relates to a push-to-communicate (PTC) associating server. The PTC associating server can include a processor that receives a PTC session initiation request identifying a first PTC address as a destination address for a PTC communication session. The processor can automatically associate the PTC session initiation request with at least a second PTC address. The processor can also automatically generate a session modification request requesting that at least one communication device associated with the second PTC address be added as a participant in the PTC communication session.

The present invention also relates to a program storage device readable by a machine, tangibly embodying a program of instructions executable by the machine to perform the various steps and/or functions described herein.

### BRIEF DESCRIPTION OF THE DRAWINGS

Preferred embodiments of the present invention will be described below in more detail, with reference to the accompanying drawings, in which:

FIG. 1 depicts a communication system that is useful for understanding the present invention;

FIG. 2 depicts a signaling flow diagram that is useful for understanding the present invention;

FIG. 3 depicts a block diagram of a push-to-communicate (PTC) associating server that is useful for understanding the present invention; and

FIG. 4 is a flowchart presenting a method of handling a PTC communication session that is useful for understanding the present invention.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The present invention relates to a method and a system for handling push-to-communicate (PTC) communication sessions. As used herein, a PTC communication session is any push-to-transmit communication session. Examples of PTC communication sessions can include, but are not limited to, push-to-talk (PTT) communication sessions, PTT over cellular (PoC) communication sessions and push-to-experience (PTx) communication sessions. Further, as used herein, a PTC address is an address of a half duplex PTC communication device or service with which a communication session can be established.

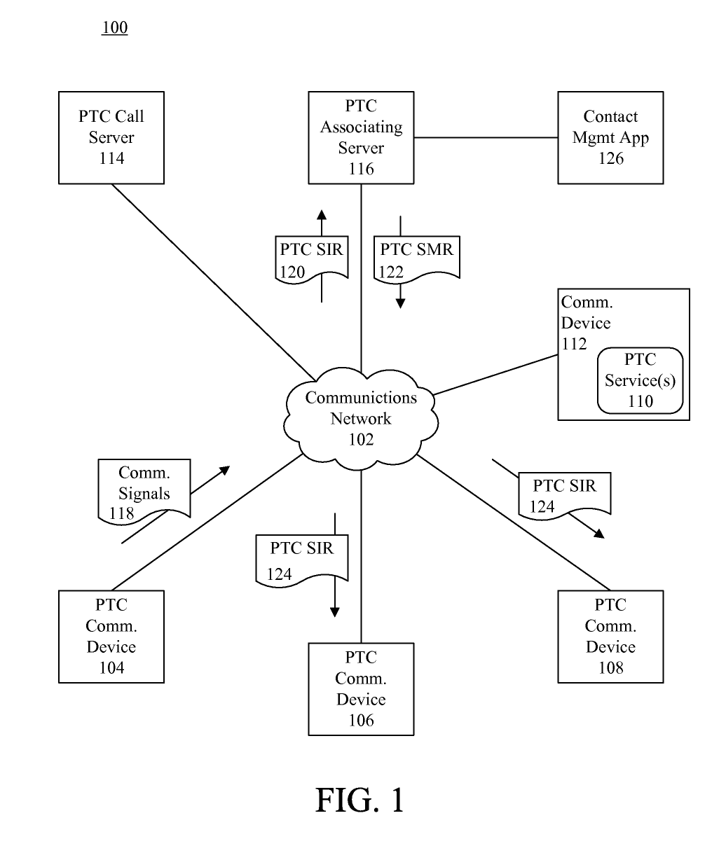

FIG. 1 depicts a communication system 100 that is useful for understanding the present invention. The communications system 100 can include a communications network 102, which may comprise any suitable network infrastructure over which half duplex communication signals can be sent. The communications network 102 can include, for example a dispatch communications network, a cellular communications network, a wide area network (WAN), such as the Internet, the World Wide Web and the like. Other examples of suitable network infrastructure may include, but are not limited to, a radio access network (RAN), a local area network (LAN), a metropolitan area network (MAN), a WiFi network, a Mesh network, a public safety network (e.g. Astro, TETRA, HPD, etc.) and/or any other networks or systems over which communication signals can be propagated. In that regard, the communications network 102 can include wired and/or wireless communication links.

The communications network 102 can be configured to communicate data via IEEE 802 wireless communications, for example, 802.11 and 802.16 (WiMAX), 3G, 4G, WPA, WPA2, GSM, TDMA, CDMA, WCDMA, OFDM, direct wireless communication, or any other communications format. Indeed, the communications network 102 can be implemented in accordance with any suitable communications standards, protocols, and/or architectures, or a suitable combination of such standards, protocols, and/or architectures.

The communications system 100 can also include a plurality of PTC communication devices 104, 106, 108 addressed using PTC addresses and which communicate via the communications network 102. The PTC communication devices 104-108 can be, for instance, mobile radios configured to communicate via the communications network 102. As such, the PTC communication devices 104-108 can comprise one or more processors/controllers, transceivers, data storage devices, user interfaces, and/or other suitable components. Further, one or more of the PTC communication devices 104-108 can be configured to communicate with one other PTC communication device or system, or with a plurality of other PTC communication devices or systems, for example in a group call.

One or more PTC services 110 can also be provided in the communications system 100. The PTC services 110 can be any services that are addressed using PTC addresses and which are accessible to the PTC communication devices 104-108. Examples of PTC services 110 can include, but are not limited to, weather services, traffic services, recreational services, and the like. In one arrangement, the PTC services 110 can receive location information for one or more PTC communication devices active in a PTC communication session and provide location specific services, for example location specific weather reports. The PTC services 110 can be hosted by a communication device 112, such as a server, another PTC associating server, another PTC call server, or another suitable system. In that regard, the communication device 112 can be assigned at least one PTC address for each PTC service 110 hosted by the communication device 112.

The communications system 100 can also include a PTC call server 114 and a PTC associating server 116, each of which may also comprise one or more processors/controllers, network adapters, data storage devices, and/or other suitable components. The PTC call server 114 can route half duplex communication signals, such communication signals 118 generated by the PTC communication device 104, to their destination addresses. The PTC call server 114 can also receive and send PTC session initiation requests and acknowledgements. Such operations are known to those skilled in the art of PTC communications.

The PTC associating server 116 can receive a PTC session initiation request 120 whose destination address (or blocks of destination addresses in a group communication session) identifies a call associating function of the PTC associating server 116. For example, the PTC associating server 116 can receive the PTC session initiation request 120 from the PTC call server 114 in response to the PTC call server 114 receiving from the PTC communication device 104 a PTC session initiation request that is addressed to the call associating function.

The PTC associating server 116 can identify PTC addresses of one or more PTC communication devices 106, 108 or PTC services 110 (hosted on the communication device 112) to which corresponding PTC session initiation requests can be communicated. Further, the PTC associating server 116 can associate the PTC session initiation request 120 with the identified PTC addresses. For example, the PTC associating server 116 can store the PTC addresses of the respective PTC communication devices 104-108 and associate such PTC addresses with the communication session in which the PTC session initiation request 120 was received.

The PTC associating server 116 then can communicate to the PTC call server 114 a PTC session modification request 122 which requests that the communication device(s) 106, 108 and/or the communication device 112 be added as participants to the communication session. In response to the PTC session modification request 122, the PTC call server 114 can communicate one or more corresponding PTC session initiation requests 124 to the PTC communication device(s) 106, 108 using the identified PTC addresses. In one arrangement, the PTC communication device(s) 106, 108 can be associated with a call group to which the PTC session initiation request 124 is forwarded. Alternatively, the PTC session initiation request 124 can be communicated to the communication device 112, for example if the PTC session initiation request 120 was directed to a PTC address associated with a PTC service 110.

In one arrangement, the PTC associating server 116 can withdraw from the PTC communication session. For example, after receiving an acknowledgement indicating that the communication device 104, the communication device 106 and/or the communication device 112 has joined the PTC communication session, the PTC associating server 116 can communicate a request to the PTC call server 114 requesting that the PTC associating server's participation in the PTC communication session be terminated.

In another arrangement, the PTC associating server 116 can continue to monitor all or part of the communication session between the first PTC communication device 104 and the second PTC communication device(s) 106, 108 (or the PTC services 110). For example, the PTC associating server 116 can monitor conditions associated with the PTC communication session, communications communicated during the communication session, or both the conditions and the communications. The conditions associated with the PTC communication session may include, but are not limited to, a present time, an amount of time lapsed during the communication session, a present location of the PTC communication device 104, present locations of the PTC communication devices 106, 108, addition of other PTC communication devices to the communication session, removal of PTC communication devices from the communication session, transfer of communication session participation from a first PTC communication device to a second PTC communication device, and so on.

In response to detecting changes for one or more conditions, the PTC associating server 116 can add one or more other communication devices to the communication session, remove one or more communication devices from the communication session, modify PTC address associations in the communication session, etc. For example, if a shift has ended for a user associated with the PTC communication device 106, but a shift has started for a user of the PTC communication device 108, the PTC associating server 116 can request the PTC call server 114 to remove the communication device 106 from the communication session and to add the communication device 108 to the communication session.

The PTC associating server 116 can identify the PTC addresses of the PTC communication devices 106, 108 in any suitable manner. For example, the PTC associating server 116 can interface with a contact management application 126. The contact management application may be contained on the PTC associating server 116 or otherwise communicatively linked to the PTC associating server 116, for instance via a communications bus, a LAN or the communications network 102.

By way of example, assume that the destination address for a PTC session initiation request 120 is a general PTC address for a security department, and the security department's PTC address is assigned to the PTC associating server 116. In response to receiving the PTC session initiation request 120 addressed to the security department's PTC address, the PTC associating server 116 can interface with the contact management application 126 to identify one or more security guards presently on duty, as well as the PTC addresses of the PTC communication devices 106, 108 that are assigned to the security guards.

Any of a myriad of PTC address selection parameters can be processed to select the PTC addresses of the PTC communication devices 106, 108. Such parameters can include, but are not limited to, a time of day, a present day, week, month or year, a present location of one or more individuals or objects, an availability of a PTC communication device 106, 108 or an individual to whom the PTC communication device 106, 108 is assigned, scheduled times on a duty roster, and so on.

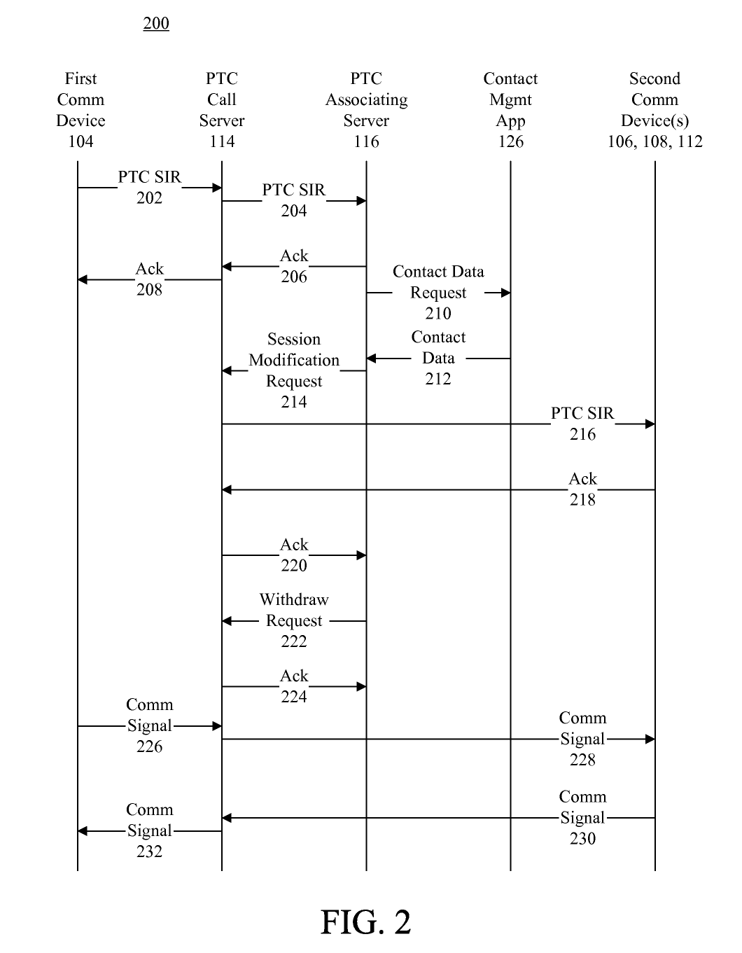

FIG. 2 depicts a signaling flow diagram 200 that is useful for understanding the present invention. The signaling flow diagram 200 is described in reference to a communication session initiated by the first PTC communication device 104 that results in a communication session being established that includes the first PTC communication device 104 and one or more of the PTC communication devices 106, 108. Notwithstanding, it will be appreciated by those skilled in the art that the signaling flow diagram 200 is also applicable to establishing a communication session that includes the first PTC communication device 104 and the communication device 112, which may provide the PTC services 110 previously described. In such an arrangement, the communication device 112 will replace the second PTC communication devices 106, 108 in the signaling flow diagram 200 and in the following description of the signaling flow diagram 200.

At step 202, the first PTC communication device 104 can communicate to the PTC call server 114 a first PTC session initiation request identifying as a destination address a PTC address associated with the PTC associating server 116. In response to the first PTC session initiation request, at step 204 the PTC call server 114 can communicate a second PTC session initiation request to the PTC associating server 116. At step 206, the PTC associating server 116 can respond to the second PTC session initiation request with an acknowledgement communicated to the PTC call server 114 indicating that the PTC session initiation request has been received. In response, at step 208 the PTC call server 114 can communicate a corresponding acknowledgement 208 to the first communication device 104. Receipt of the acknowledgement by the first PTC communication device 104 can complete initialization of a communication session between the first PTC communication device 104 and the PTC associating server 116.

At step 210, the PTC associating server 116 can communicate a contact data request to the contact management application 126. At step 212, the contact management application 126 can respond to the request with information for one or more contacts. The PTC associating server 116 can process such information, as well the PTC address selection parameters, to identify one or more PTC addresses of the PTC communication devices 106, 108 which should be added to the communication session.

In another arrangement, in lieu of requesting contact information, the PTC associating server 116 can communicate to the contact management application 126 the PTC address selection parameters, and the contact management application 126 can process such parameters to identify the PTC address(es). The contact management application 126 then can communicate the identified PTC address(es) to the PTC associating server 116.

Once the PTC address(es) of the PTC communication device(s) 106, 108 has/have been identified to the PTC associating server 116, at step 214 the PTC associating server 116 can communicate a session modification request to the PTC call server 114 requesting that the PTC call server 114 add one or more of the PTC communication devices 106, 108 to the communication session. In response, at step 216 the PTC call server 114 can forward a PTC session initiation request to the second PTC communication device(s) 106, 108.

At step 218, one or more of the PTC communication device 106, 108 can communicate to the PTC call server 114 an acknowledgement responding to the PTC session initiation request. At step 220 the PTC call server 114 can communicate a corresponding acknowledgement to the PTC associating server 116. Receipt of the acknowledgement by the PTC associating server 116 can complete the process of the PTC communication device(s) 106, 108 joining the communication session, which was originally established between the first PTC communication device 104 and the PTC associating server 116. Accordingly, the first PTC communication device 104 and the second PTC communication device(s) 106, 108 then can communicate among one another without requiring further interaction with the PTC associating server 116.

Optionally, at step 222 the PTC associating server 116 can communicate a withdraw request to the PTC call server 114. The withdraw request can be a request to end the PTC associating server's participation in the communication session. At step 224, the PTC call server 114 can respond with an acknowledgement. Receipt of the acknowledgement by the PTC associating server 116 can complete the PTC associating server's requested termination in the communication session. In another arrangement, rather than opting out of the communication session, the PTC associating server 116 can continue to monitor the communication session, as previously described.

At step 226, the PTC communication device 104 can communicate to the PTC call server 114 a communication signal addressed to the PTC communication device(s) 106, 108. At step 228 the PTC call server 114 can forward the communication signal to the second PTC communication device(s) 106, 108.

At step 230, at least one of the PTC communication devices 106, 108 can generate a communication signal addressed to the PTC communication device 104 and communicate the communication signal to the PTC call server 114. At step 232, the PTC call server 114 can communicate the communication signal to the PTC communication device 104.

The signaling flow diagram 200 can also be implemented in response to other PTC session initiation requests received from a third PTC communication device (not shown). In one arrangement, at step 212 the contact data can be processed such that a PTC address or PTC addresses that are identified are not addresses associated with the second PTC communication devices 106, 108, but rather are one or more PTC addresses associated with at least a fourth PTC communication device (not shown). In this manner incoming calls can be distributed among a plurality of recipients so that a particular recipient, or group of recipients, is not consistently tasked with answering all incoming calls.

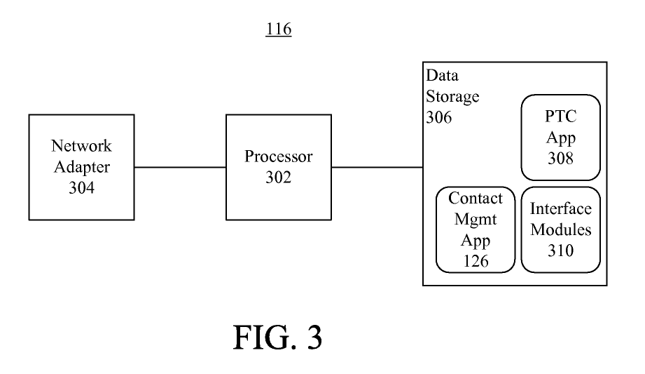

FIG. 3 depicts a block diagram of the PTC associating server 116 that is useful for understanding the present invention. The PTC associating server 116 can include a processor 302. The processor 302 can comprise, for example, one or more central processing units (CPUs), one or more digital signal processors (DSPs), one or more application specific integrated circuits (ASICs), one or more programmable logic devices (PLDs), a plurality of discrete components that can cooperate to process data, and/or any other suitable processing device. In an arrangement in which a plurality of such components are provided, the components can be coupled together to perform various processing functions as described herein.

The PTC associating server 116 can also include a network adapter 304. The network adapter can be configured to communicate with the PTC communication devices/PTC call server via the communications network, and can do so via wired and/or wireless communication links. Such network adapters are known to the skilled artisan.

The PTC associating server 116 further can include a data storage 306. The data storage 306 can include one or more storage devices, each of which can include, but is not limited to, a magnetic storage medium, an electronic storage medium, an optical storage medium, a magneto-optical storage medium, and/or any other storage medium suitable for storing digital information. In one arrangement, the data storage 306 can be integrated into the processor 302, though this need not be the case.

A PTC application 308 and the contact management application 126 can be stored on the data storage 306. Alternatively, the contact management application 126 can be stored elsewhere and accessed by the PTC application 308 via a communications bus or communications network, as noted.

The processor 302 can execute the PTC application 308 to implement the methods and processes described herein. For example, while the PTC application 308 is instantiated on the PTC associating server 116, the processor 302 can receive via the network adapter 304 a PTC session initiation request identifying a particular PTC address as the destination address. The processor 302 can also interface with the contact management application 126 to select one or more PTC addresses to associate with the PTC session initiation request, and automatically generate a session modification request requesting that communication devices associated with the second PTC address(es) be added as participants to the communication session. The processor 302 can also monitor the communication session, withdraw from the communication session, generate additional session modification requests, and so on.

A plurality of interface modules 310 can also be contained on the data storage 306. The interface modules 310 can support the interface of the PTC application 308 with other applications, devices and/or systems. In one arrangement, the interface modules 310 can be components of the PTC application 308. Alternatively, one or more interface modules 310 may be implemented at another system layer, for instance within an operating system instantiated on the PTC associating server 116.

Examples of the interface modules 310 can include, but are not limited to, a web interface module (e.g. in accordance with HTTP, HTTPX, etc.), an application interface module (e.g. to interface with the contact management application 126), an active directory interface (e.g. in accordance with the lightweight directory access protocol (LDAP), a database interface (e.g. in accordance with structured query language (SQL)), an extensible markup language (XML) interface, and a time interface (e.g. to receive Internet time or other suitable time information). Other interface modules that can be implemented may include an Open Mobile Alliance (OMA) push-to-talk over cellular (PoC) interface, a session initiation protocol (SIP) interface, a configuration access protocol (XCAP) interface (e.g. for group creation), and an interface for real time control protocol (e.g. to implement floor control). Still, any other interface modules can be used to facilitate communication between the PTC application 308 and other applications, devices and/or systems, and the invention is not limited in this regard.

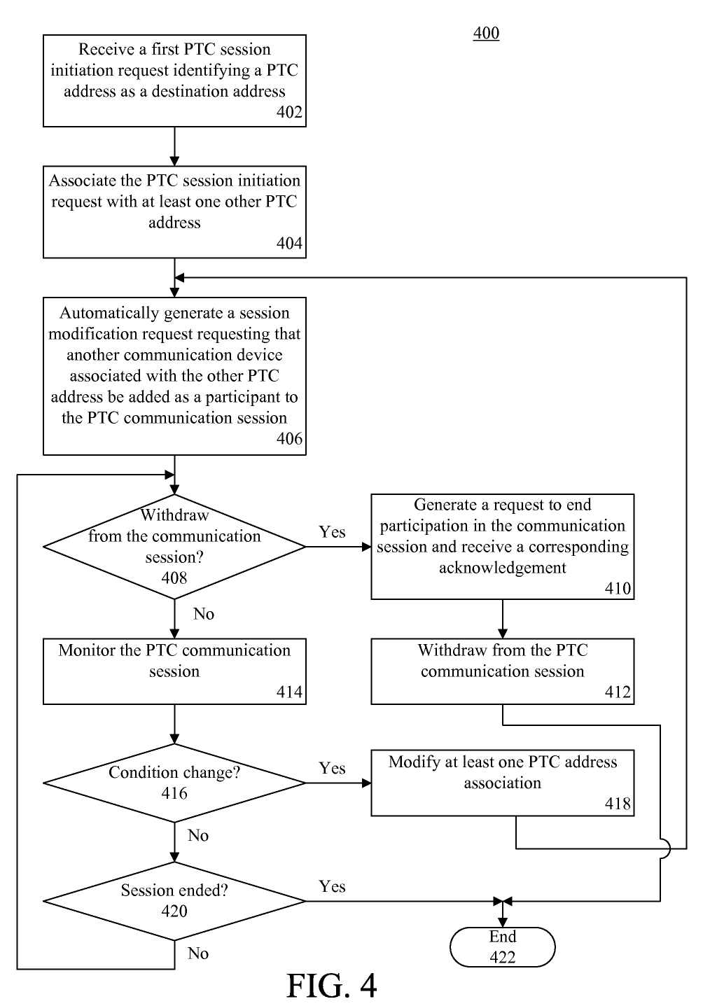

FIG. 4 is a flowchart presenting a method 400 of handling a PTC communication session that is useful for understanding the present invention. At step 402 a PTC session initiation request can be received by a PTC associating server. The PTC session initiation request can identify a PTC address as a destination address. At step 404, at least one other PTC address can be identified based on one or more parameters, for example a time of day, a present location and/or an availability of a communication device, and the PTC session initiation request can be associated with the other PTC address(es). For example, the destination PTC address and the other PTC address(es) each can be associated with the PTC communication session.

At step 406, a session modification request can be automatically generated. The session modification request can request that another communication device associated with the other PTC address be added as a participant to the communication session. Communication devices corresponding to the other PTC address(es) then can be invited to join the communication session.

Referring to decision box 408, if the PTC associating server chooses to withdraw from the communication session, for example based on identified conditions, at step 410 the PTC associating server can generate a request to end participation in the communication session. In response to receiving a corresponding acknowledgement, the process can proceed to decision box 412 and the PTC associating server can withdraw from the communication session. If the PTC associating server does not choose to withdraw from the communication session, at step 414 the PTC associating server can monitor the communication session.

Continuing to decision box 416, if the PTC associating server detects a condition change in the communication session, for example an employee associated with a particular PTC address is going off duty, at step 418 the PTC associating server can modify at least one PTC address association. For example, one or more PTC addresses can be disassociated with the communication and one or more PTC addresses can be associated with the communication session. The process then can return to step 406 and another session modification request can be generated. Such session modification request can request that communication devices corresponding to the newly associated PTC addresses be added as participants to the communication session and request that communication devices corresponding to the disassociated PTC addresses be removed as participants to the communication session.

Referring to decision box 420, while the communication session remains active, the process can return to decision box 408. Otherwise, the process can end at step 422.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The present invention can be realized in hardware, software, or a combination of hardware and software. The present invention can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with an application that, when being loaded and executed, controls the processing system such that it carries out the methods described herein. The present invention can also be embedded in a program storage device readable by a machine, tangibly embodying a program of instructions executable by the machine to perform methods and processes described herein. The present invention can also be embedded in an application product which comprises all the features enabling the implementation of the methods described herein and, which when loaded in a processing system, is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a script, a subroutine, a function, a procedure, an object method, an object implementation, an executable application, an applet, a servlet, a MIDlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language).

This invention can be embodied in other forms without departing from the spirit or essential attributes thereof. Accordingly, reference should be made to the following claims, rather than to the foregoing specification, as indicating the scope of the invention.

What is claimed is:

1. A method of handling a push-to-communicate (PTC) communication session, comprising:
receiving a PTC session initiation request identifying a first PTC address as a destination address;
automatically associating the PTC session initiation request with at least a second PTC address; and
automatically generating a session modification request requesting that at least one communication device associated with the second PTC address be added as a participant in the PTC communication session.

2. The method of claim 1, further comprising:
responsive to receiving an acknowledgement in response to the session modification request, generating a request to end participation in the communication session.

3. The method of claim 1, wherein associating the PTC session initiation request with the second PTC address comprises associating the first PTC address and the second PTC address with the PTC communication session.

4. The method of claim 1, wherein identifying the second PTC address comprises:
identifying at least one present condition; and
identifying that the second PTC address corresponds to the present condition.

5. The method of claim 4, wherein identifying the present condition comprises identifying at least one parameter selected from the group consisting of a time of day, a present location, and an availability of the communication device.

6. The method of claim 4, wherein identifying that the second PTC address corresponds to the present condition comprises:
communicating a contact data request to a contact management application, the contact data request comprising at least one indicator of the present condition; and
receiving a response to the contact data request, the response identifying the second PTC address.

7. The method of claim 1, wherein automatically generating a session modification request comprises generating a session modification request which requests that a communication device hosting at least one PTC service be added as a participant in the communication session.

8. The method of claim 1, further comprising:
monitoring conditions associated with the PTC communication session; and
responsive to detecting at least one condition change, modifying at least one PTC address association.

9. The method of claim 8, further comprising generating a second session modification request requesting that at least one communication device associated with at least a third PTC address be added as a participant in the PTC communication session.

10. A push-to-communicate (PTC) associating server, comprising:
a processor that receives a PTC session initiation request identifying a first PTC address as a destination address for a PTC communication session, automatically associates the PTC session initiation request with at least a second PTC address, and automatically generates a session modification request requesting that at least one communication device associated with the second PTC address be added as a participant in the PTC communication session.

11. The PTC associating server of claim 10, wherein:
responsive to the PTC associating server receiving an acknowledgement in response to the session modification request, the PTC associating server generates a request to end participation in the communication session.

12. The PTC associating server of claim 10, wherein the processor associates the first PTC address and the second PTC address with the PTC communication session.

13. The PTC associating server of claim 10, wherein the processor identifies at least one present condition and identifies that the second PTC address corresponds to the present condition.

14. The PTC associating server of claim 13, wherein the present condition identified by the processor comprises at least one parameter selected from the group consisting of a time of day, a present location, and an availability of the communication device.

15. The PTC associating server of claim 13, wherein:
the processor communicates a contact data request to a contact management application, the contact data request comprising at least one indicator of the present condition; and
the processor receives a response to the contact data request, the response identifying the second PTC address.

16. The PTC associating server of claim 10, wherein the session modification request is a request to add as a participant in the communication session a communication device hosting at least one PTC service.

17. The PTC associating server of claim 10, wherein:
the processor monitors conditions associated with the PTC communication session; and
the processor modifies at least one PTC address association in response to detecting at least one condition change.

18. The PTC associating server of claim 17, wherein the processor requests that at least one communication device associated with at least a third PTC address be added as a participant in the PTC communication session.

19. A program storage device readable by a machine, tangibly embodying a program of instructions executable by the machine to perform method steps for handling a push-to-communicate (PTC) communication session, said method steps comprising:
receiving a PTC session initiation request identifying a first PTC address as a destination address;
automatically associating the PTC session initiation request with at least a second PTC address; and
automatically generating a session modification request requesting that at least one communication device associated with the second PTC address be added as a participant in the PTC communication session.

20. The program storage device of claim 19, said method steps further comprising:
responsive to receiving an acknowledgement in response to the session modification request, generating a request to end participation in the communication session.
